(19) United States
(12) Patent Application Publication
(10) Pub. No.: US 2009/0160635 A1
(43) Pub. Date: Jun. 25, 2009

(54) METHOD FOR THE DISTRIBUTION OF EMERGENCY ALERT INFORMATION OVER AN IP HOME NETWORK

(76) Inventor: Rajendra Bopardikar, Phoenix, AZ (US)

Correspondence Address: INTEL CORPORATION;c/o CPA Global, P.O. BOX 52050, MINNEAPOLIS, MN, 55402, US

(21) Appl. No.: 11/963,206

(22) Filed: Dec. 21, 2007

(51) Int. Cl. G08B 1/00

(52) U.S. Cl. 340/531

(57) ABSTRACT

In some embodiments, a method for the distribution of emergency alert information over an IP home network is presented. In this regard, an alert agent is introduced to receive an emergency alert, to discover remote user interface (RUI) clients on a home network, to construct custom alerts for the discovered RUI clients and to push the custom alerts to the discovered RUI clients. Other embodiments are also disclosed and claimed.

### FIELD OF THE INVENTION

Embodiments of the present invention generally relate to the field of emergency alerts, and, more particularly to a method for the distribution of emergency alert information over an IP home network.

### BACKGROUND OF THE INVENTION

The Emergency Alert System (EAS) is a national system in the U.S. that was put into place in 1994 and is jointly administered by the Federal Communications Commission (FCC), Federal Emergency Management Agency (FEMA), and the National Weather Service (NWS). At present the EAS system is applicable to traditional radio and television companies.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example network environment for implementing the distribution agent, in accordance with one example embodiment of the invention;

FIG. 2 is a block diagram of an example distribution agent architecture, in accordance with one example embodiment of the invention;

FIG. 3 is a flow chart of an example method for the distribution of emergency alert information over an IP home network, in accordance with one example embodiment of the invention; and

FIG. 4 is a block diagram of an example article of manufacture including content which, when accessed by a device, causes the device to implement one or more aspects of one or more embodiment(s) of the invention.

### DETAILED DESCRIPTION

Embodiments of the present invention are generally directed to a method for the distribution of emergency alert information over an IP home network. In this regard, in accordance with but one example implementation of the broader teachings of the present invention, a distribution agent is introduced. In accordance with but one example embodiment, the distribution agent employs an innovative method to distribute emergency alert information over an IP home network. According to one example method, the distribution agent receives an emergency alert, discovers remote user interface (RUI) clients on a home network, constructs custom alerts for the discovered RUI clients and pushes the custom alerts to the discovered RUI clients.

FIG. 1 is a block diagram of an example network environment for implementing the distribution agent, in accordance with one example embodiment of the invention. Network environment 100 is intended to represent any of a wide variety of suitable network environments. In accordance with the illustrated example embodiment, network environment 100 may include one or more of external network 102, distribution agent 104, home network 106, client 108, and client 110 coupled as shown in FIG. 1. Distribution agent 104, as described more fully hereinafter, may well be used in network environments of greater or lesser complexity than that depicted in FIG. 1. Also, the innovative attributes of distribution agent 104 as described more fully hereinafter may well be embodied in any combination of hardware and software. While shown as being part of a separate device or unit, distribution agent 104 may well be incorporated into another device or appliance, such as, for example, a set top box. Additionally, distribution agent 104 may be implemented in software or a combination of hardware and software.

External network 102 represents any network or service provider capable of providing emergency alerts to distribution agent 104. In one embodiment, external network 102 represents a cable television provider that broadcasts emergency alerts in MPEG format as specified in the Consumer Electronics Association (CEA)-814 standard. In another embodiment, external network 102 represents an internet service provider that broadcasts emergency alerts. In another embodiment, external network 102 represents an internet content provider that is capable of pushing emergency alerts to distribution agent 104.

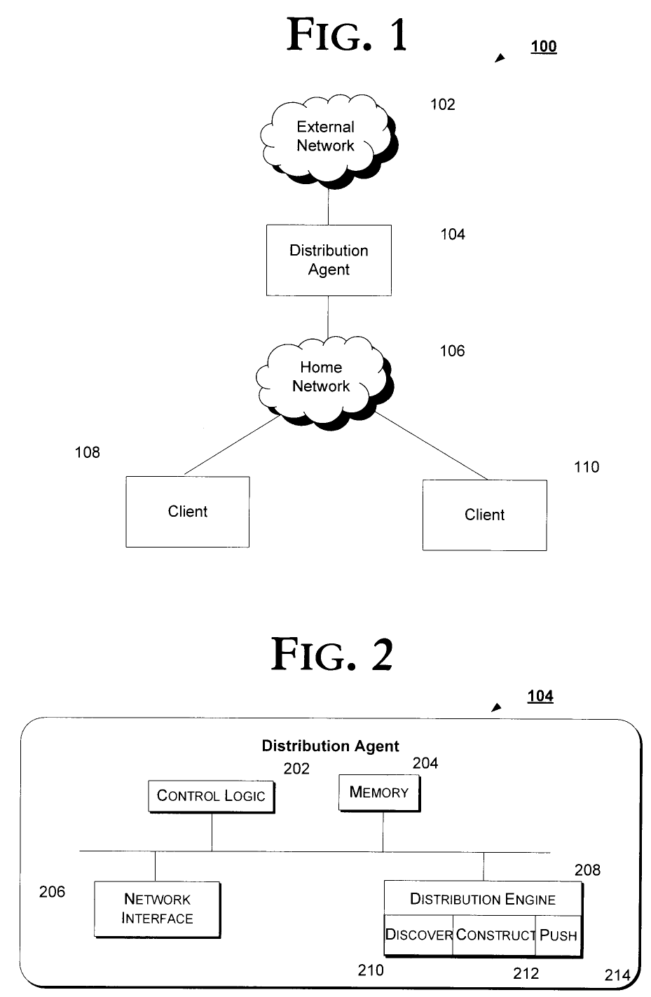

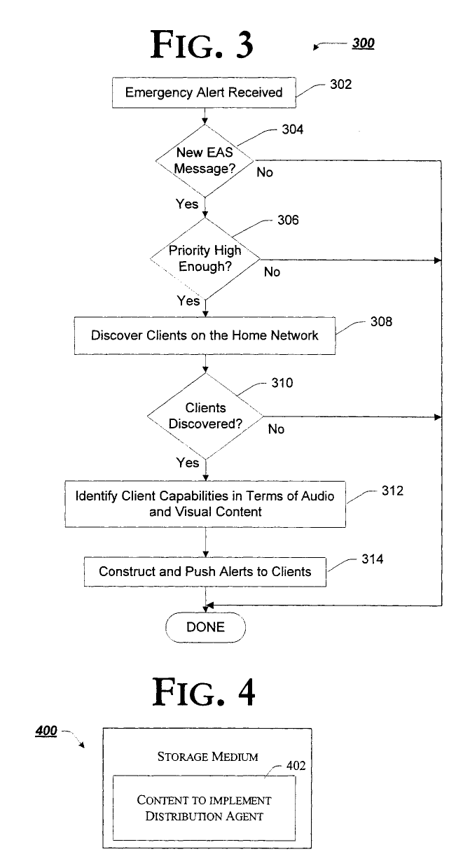

Distribution agent 104 may have an architecture as described in greater detail with reference to FIG. 2. Distribution agent 104 may also perform one or more methods for the distribution of emergency alert information over an IP home network, such as the method described in greater detail with reference to FIG. 3. In one embodiment, distribution agent 104 represents a Level 1 or Level 2 remote user interface (RUI) server within home network 106 as specified in the CEA-2014 standard. In another embodiment, distribution agent 104 represents a Level 0 RUI server within external network 102.

Home network 106 represents a wired or wireless network for interconnection of devices within a home. In one embodiment, home network 106 represents an 802.11 wireless network. In another embodiment, home network 106 represents an Ethernet network. In one embodiment, home network 106 is a Universal Plug and Play (UPnP) compliant network.

Clients 108 and 110 represent any type of electronic device, such as, for example, televisions, telephones, laptops, desktops, stereos, video games, etc. In one embodiment, clients 108 and 110 include visual and/or audio capabilities for interfacing with a user which may be available as a RUI client.

FIG. 2 is a block diagram of an example distribution agent architecture, in accordance with one example embodiment of the invention. As shown, distribution agent 104 may include one or more of control logic 202, memory 204, network interface 206, and distribution engine 208 coupled as shown in FIG. 2. In accordance with one aspect of the present invention, to be developed more fully below, distribution agent 104 may include a distribution engine 208 comprising one or more of discover services 210, construct services 212, and/or push services 214. It is to be appreciated that, although depicted as a number of disparate functional blocks, one or more of elements 202-214 may well be combined into one or more multi-functional blocks. Similarly, distribution engine 208 may well be practiced with fewer functional blocks, i.e., with only construct services 212, without deviating from the spirit and scope of the present invention, and may well be implemented in hardware, software, firmware, or any combination thereof. In this regard, distribution agent 104 in general and distribution engine 208 in particular are merely illustrative of one example implementation of one aspect of the present invention. As used herein, distribution agent 104 may well be embodied in hardware, software, firmware and/or any combination thereof.

As used herein control logic 202 provides the logical control of distribution agent 104. In this regard, control logic 202 may manage one or more aspects of distribution agent 104 to interact with other devices on external network 102 and home network 106.

According to one aspect of the present invention, though the claims are not so limited control logic 202 may receive event indications such as, e.g., receipt of an emergency alert. Upon receiving such an indication, control logic 202 may selectively invoke the resource(s) of distribution engine 208. As part of an example method for the distribution of emergency alert information over an IP home network, as explained in greater detail with reference to FIG. 3, control logic 202 may selectively invoke discover services 210 that may discover client devices on home network 106. Control logic 202 also may selectively invoke construct services 212 or push services 214, as explained in greater detail with reference to FIG. 3, to construct custom alerts for client devices or to push the custom alerts to the client devices, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may also include, among others: polymer memory, battery backed DRAM, RDRAM, NAND/NOR memory, flash memory, or Ovonics memory. In one embodiment, memory 204 may be part of a processor, system disk, or network cache. Memory 204 may be used to store emergency alerts and information about clients 108 and 110, for example.

Network interface 206 provides a path through which distribution agent 104 can communicate with other devices on external network 102 and home network 106, for example clients 108 and 110. In one embodiment, network interface 206 may represent a wireless interface. In one embodiment, network interface 206 represents separate interfaces for external network 102 and home network 106.

Discover services 210, as introduced above, may provide distribution agent 104 with the ability to discover client devices on home network 106. In one embodiment, discover services 210 functions as a RUI server to identify audio and visual capabilities of discovered RUI clients 108 and 110 on home network 106.

As introduced above, construct services 212 may provide distribution agent 104 with the ability to construct custom alerts for client devices. In one example embodiment, construct services 212 constructs custom alerts for clients 108 and 110 based at least in part on the audio and visual capabilities identified by discover services 210. For example, if client 108 had some video capabilities but no audio capabilities, construct services 212 may construct a custom alert for client 108 that conveys the alert information using the video capabilities of client 108. In one example embodiment, construct services constructs custom alerts for clients 108 and 110 based at least in part on a priority level encoded within the emergency alert. For example, construct services 212 may create more prominent (i.e. full screen) custom alerts when the emergency alert contains a higher priority. In one embodiment, construct services 212 may construct custom alerts the convey information encoded in an emergency alert header. For example, construct services 212 may include information from the Specific Area Message Encoding (SAME) header into the custom alert. In one embodiment, construct services 212 may read the emergency alert header and determine a distribution for the emergency alert based on contents in the header. For example, construct services 212 may not construct a custom alert for client 108 and/or client 110 if it is determined based on contents in the header that the emergency alert is not appropriate for home network 106, for example because the emergency alert is intended for a different geography.

Push services 214, as introduced above, may provide distribution agent 104 with the ability to push the custom alerts to the client devices. In one embodiment push services 214 functions as a RUI server to render the custom alerts on RUI clients 108 and 110. In one embodiment, push services 214 creates a pop-up window containing the custom alerts on a display of clients 108 and 110.

FIG. 3 is a flow chart of an example method for the distribution of emergency alert information over an IP home network, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 3 begins with control logic 202 responding to the receipt (302) of an emergency alert. In one example embodiment, the emergency alert is received in MPEG format according to the CEA-814 standard from external network 102. In one embodiment, emergency alerts received are saved to memory 204.

Control logic 202 may then decide (304) if the emergency alert service message received is a new message or not. In one embodiment, control logic 202 will compare an emergency alert received with messages already stored in memory 204. Control logic 202 may then decide (306) if the message is a high enough priority to generate custom alerts. In one embodiment, control logic 202 will not act on emergency alerts received that are test messages.

Next, discover services 212 may be called to discover (308) clients on the home network. In one embodiment, discover services 212 may utilize universal plug and play (UPnP) protocols to identify clients 108 and 110 on home network 106. In another embodiment, push services 214 may roll-back and reattempt a transaction when there is contention. If discover services 212 does discover (310) clients on the home network, discover services 212 may then identify (312) client capabilities in terms of audio and visual content. In one embodiment, discover services 212 may make a yes or no determination as to the audio and visual capabilities of a client. In another embodiment, discover services 212 may classify the audio and visual capabilities of a client on a scale system based on a predefined amount of capability.

Control logic 202 may then invoke construct services 212 and push services 214 to construct and push (314) alerts to clients. In one embodiment, the SAME header information is displayed in text format in the xhtml UI. In another embodiment, the audio/video announcement is embedded inside the xhtml UI. The traditional audio attention signal associated with emergency messages may or may not be included inside the xhtml UI.

FIG. 4 illustrates a block diagram of an example storage medium comprising content which, when accessed, causes an electronic appliance to implement one or more aspects of the distribution agent 104 and/or associated method 300. In this regard, storage medium 400 includes content 402 (e.g., instructions, data, or any combination thereof) which, when executed, causes the appliance to implement one or more aspects of distribution agent 104, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
receiving an emergency alert;
discovering remote user interface (RUI) clients on a home network; and
constructing custom alerts for the discovered RUI clients.

2. The method of claim 1, further comprising:
pushing the custom alerts to the discovered RUI clients.

3. The method of claim 1, wherein constructing custom alerts for the discovered RUI clients comprises:
identifying audio and visual capabilities of the discovered RUI clients; and
constructing custom alerts for the discovered RUI clients based at least in part on the identified capabilities.

4. The method of claim 1, wherein constructing custom alerts for the discovered RUI clients comprises:
constructing custom alerts based at least in part on a priority level encoded within the emergency alert.

5. The method of claim 1, wherein constructing custom alerts for the discovered RUI clients comprises:
constructing custom alerts from a Level 1 RUI server.

6. The method of claim 1, wherein constructing custom alerts for the discovered RUI clients comprises:
constructing custom alerts that convey information encoded in an emergency alert header.

7. The method of claim 1, further comprising:
reading an emergency alert header; and
determining a distribution for the emergency alert based on contents in the header.

8. The method of claim 1, wherein receiving an emergency alert comprises:
receiving a CEA-814 standard compliant emergency alert from a service provider.

9. A storage medium comprising content which, when executed by an accessing machine, causes the accessing machine to receive an emergency alert, to discover remote user interface (RUI) clients on a home network, to construct custom alerts for the discovered RUI clients and to push the custom alerts to the discovered RUI clients.

10. The storage medium of claim 9, wherein the content to construct custom alerts for the discovered RUI clients comprises content to identify audio and visual capabilities of the discovered RUI clients, and to construct custom alerts for the discovered RUI clients based at least in part on the identified capabilities.

11. The storage medium of claim 9, wherein the content to construct custom alerts for the discovered RUI clients comprises content to construct custom alerts based at least in part on a priority level encoded within the emergency alert.

12. The storage medium of claim 9, wherein the content to construct custom alerts for the discovered RUI clients comprises content to construct custom alerts from a Level 1 RUI server.

13. The storage medium of claim 9, wherein the content to construct custom alerts for the discovered RUI clients comprises content to construct custom alerts that convey information encoded in an emergency alert header.

14. The storage medium of claim 9, further comprising content which, when executed by the accessing machine, causes the accessing machine to read an emergency alert header and to determine a distribution for the emergency alert based on contents in the header.

15. The storage medium of claim 9, wherein the content to receive an emergency alert comprises content to receive a CEA-814 standard compliant emergency alert from a service provider.
